(19) United States
(12) Patent Application Publication
(10) Pub. No.: US 2026/0259589 A1
(43) Pub. Date: Sep. 3, 2026

(54) ELECTRONIC CONTROL DEVICE AND ELECTRONIC CONTROL METHOD

(71) Applicant: Nissan Motor Co., Ltd., Yokohama-shi, Kanagawa (JP)

(72) Inventor: Yasunori HASEGAWA, Kanagawa (JP)

(21) Appl. No.: 18/993,255

(22) PCT Filed: Jul. 15, 2022
(86) PCT No.: PCT/JP2022/027909

§ 371 Date: Jan. 10, 2025

(51) Int. Cl. G06F 1/30; B60R 16/023

(52) U.S. Cl. CPC G06F 1/30; B60R 16/0231

(57) ABSTRACT

An electronic control apparatus includes a master ECU, an ECU and a sub ECU. The ECU is electrically connected to the master ECU via a first bus. The sub ECU is electrically connected to the master ECU via a second bus. The master ECU include an application and a signal transferrer. The application transmits and receives signals between the sub ECU and the ECU. The signal transferrer transfers signals received from the ECU to the sub ECU. The ECU transmits a control signal to the master ECU for controlling an electronic device connected to the sub ECU. The application transmits the control signal to the sub ECU when a program of the application is in a readable state. The sub ECU drives the electronic device under fail control when the control signal is not received. The signal transferrer transmits the control signal to the sub ECU while updating the program.

### TECHNICAL FIELD

The present invention relates to an electronic control apparatus and an electronic control method.

### BACKGROUND ART

There have been known techniques for updating a computer program included in an onboard computer system. For example, an onboard computer system according to Patent Document 1 includes a master unit and slave unit that are connected over an in-vehicle network, the master unit includes a plurality of master control means forming a layered structure, and the slave unit includes a plurality of slave control means forming a layered structure. In the layered structure of the slave control means, the master unit controls an order of update such that a computer program executed by a slave control means in a lower layer is preferentially updated, and after the update, a computer program of a slave control means in a layer higher than the lower layer is updated. After the computer programs as update targets in the slave unit are updated, in the layered structure of the master control means, the master unit controls an order of update such that a computer program executed by a master control means in a lower layer is preferentially updated, and after the update, a computer program at a master control means in a layer higher than the lower layer is updated.

### PRIOR ART DOCUMENT

### Patent Document

Patent Document 1: JP 2010-195111 A

### SUMMARY OF INVENTION

### Problems to be Solved by Invention

In the above-described onboard computer system, when cooperative control using signals is performed between a master microcontroller in a lower layer in the layered structure and a slave microcontroller in a lower layer in the layered structure, the slave microcontroller in the lower layer transmits a control signal to a microcontroller in a higher layer, and an application included in the microcontroller in the higher layer transmits the control signal to the master microcontroller in the lower layer. While a program included in the application is updated, transfer of signals using the application cannot be performed. As a result, when the application included in the microcontroller in the higher layer cannot transfer signals due to the update of the program, the transmission and reception of signals between the microcontrollers in the lower layers are interrupted. As seen from the above, a problem with the above-described onboard computer system is that, while a program included in an ECU is updated, signals cannot be transmitted and received between other ECUs via the ECU including the program.

A problem to be solved by the present invention is to provide an electronic control apparatus and an electronic control method that are capable of transmitting and receiving, while a program included in an ECU is updated, signals between other ECUs via the ECU including the program.

### Means for Solving Problems

The present invention solves the above-described problem by using an application of a master ECU to transmit a signal received from an ECU to a sub ECU when a program included in the application is in a state of being readable and by using a signal transferrer included in the master ECU to transmit a signal received from the ECU to the sub ECU while the program is updated.

### Effects of Invention

According to the present invention, while a program included in an ECU is updated, signals can be transmitted and received between other ECUs via the ECU including the program.

### BRIEF DESCRIPTION OF DRAWINGS

FIG. 1 is a block diagram of a vehicle network system according to an embodiment of the present invention.

FIG. 2 is a block diagram of a master ECU, where (a) is a schematic diagram for describing a signal transfer channel when a program is not updated, and (b) is a schematic diagram for describing a signal transfer channel while a program is updated.

FIG. 3 is a block diagram illustrating a modification of the master ECU.

FIG. 4 is a block diagram illustrating a modification of the master ECU.

FIG. 5 is a block diagram illustrating a modification of the master ECU.

### MODE(S) FOR CARRYING OUT THE INVENTION

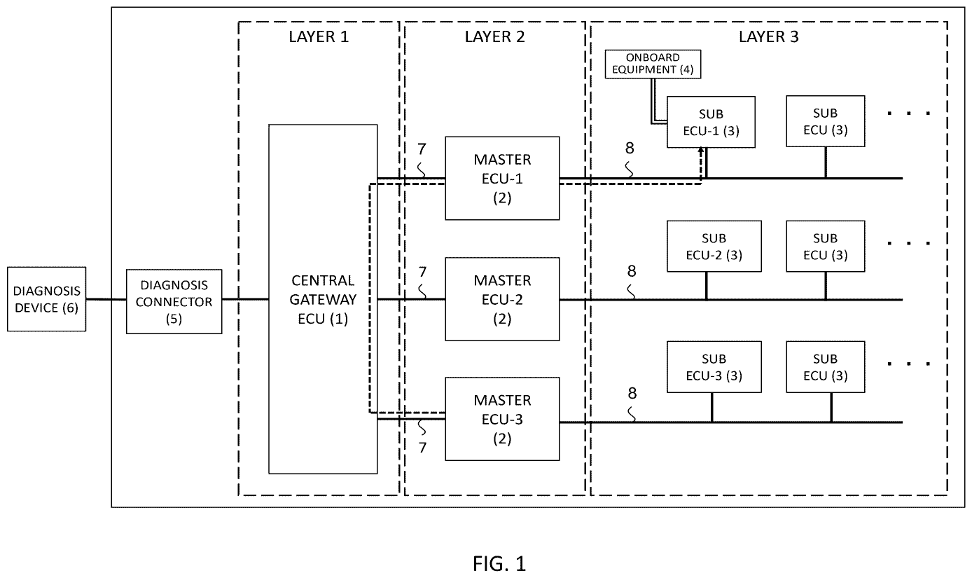

An embodiment of an electronic control apparatus and an electronic control method according to the present invention will be described below with reference to the drawings. FIG. 1 is a block diagram of a vehicle network system according to the embodiment of the present invention. A vehicle network system 100 includes a central gateway ECU 1, a plurality of master ECUs 2, a plurality of sub ECUs 3, pieces of onboard equipment 4, a diagnosis connector 5, a diagnosis device 6, and buses 7 and 8. The vehicle network system 100 is provided in a vehicle. The vehicle network system 100 includes a communication network for transmitting control signals to the pieces of onboard equipment including a battery, a motor, and a fan and includes a control unit that controls the pieces of onboard equipment. Note that an apparatus including a plurality of ECUs among the central gateway ECU 1, the master ECUs 2, and the sub ECUs 3 is equivalent to the “electronic control apparatus” according to the present invention, and control processing executed by the central gateway ECU 1 and/or the master ECUs 2 is equivalent to the “electronic control method” according to the present invention.

The communication network included in the vehicle network system 100 has a multilayered structure to accommodate an increase in the number of ECUs, an increase in the number of signals transmitted and received between the ECUs, and an increase in speed. As illustrated in FIG. 1, the communication network included in the vehicle network system 100 has a tree structure, and electronic control units (ECUs) are connected to a root part of the tree, node parts (parts at which the tree branches), and ends of the tree. The ECUs are controllers that control the pieces of onboard equipment. The ECUs transmit control signals to the pieces of onboard equipment. In addition, the ECUs each transmit and receive signals to and from the other ECUs. For example, in autonomous driving systems such as a lane keeping system and a following distance keeping system, a plurality of pieces of onboard equipment are controlled in a coordinated manner. When the plurality of pieces of onboard equipment are controlled, an ECU playing a key role in the control transmits a control signal to a piece of onboard equipment being a control target via another ECU. The ECUs each include a memory in which a program to control a piece of onboard equipment is saved, a processor that executes the program saved in the memory, and a communication module that communicates with the piece of onboard equipment and/or another ECU. Note that the above-mentioned ECUs are equivalent to the central gateway ECU 1, the master ECUs 2, and the sub ECUs 3 connected to the corresponding layers.

In the communication network illustrated in FIG. 1, three buses 7 that extend from the central gateway ECU 1, are connected to three master ECUs 2, and further branch into buses 8 that extend from the three master ECUs 2 and are connected to the sub ECUs 3. To the sub ECUs 3, the pieces of onboard equipment 4 being control targets of the sub ECUs 3 are connected. In the example in FIG. 1, in the tree that branches into three trees from the central gateway ECU 1, a master ECU and a sub ECU belonging to the first tree are denoted as a master ECU-1 and a sub ECU-1, respectively, and a master ECU 2 and a sub ECU 3 belonging to the second or third tree are denoted as a master ECU-2, 3 and a sub ECU-2, 3, respectively. The number of trees divided into is not limited to three and may be two, or four or more. In the example in FIG. 1, the ECUs are connected to three layers. However, the number of layers is not limited to three and may be two, or four or more.

As illustrated in FIG. 1, the central gateway ECU 1 is an electronic control unit (ECU) located at a top layer (layer 1) in the multilayered structure. The central gateway ECU 1 is a control unit that controls the entire vehicle. The central gateway ECU 1 transmits signals to the plurality of sub ECUs 3 via the master ECUs 2. The central gateway ECU 1 also transmits a control signal received from a master ECU 2 or a sub ECU 3 to another ECU. That is, the central gateway ECU 1 has a function of transferring a control signal between ECUs at lower layers. The central gateway ECU 1 manages IDs that are given to the ECUs at the lower layers and/or the pieces of onboard equipment 4. When a control signal from a master ECU 2 or a sub ECU 3 is received, the central gateway ECU 1 specifies an ECU as a transmission destination from an ID included in the control signal. After specifying the ID, the central gateway ECU 1 transmits the control signal to a tree that includes the ECU indicated by the specified ID. As seen from the above, the central gateway ECU 1 is connected to the nodes on the network and functions as a hub.

The master ECUs 2 are ECUs located at a middle layer (layer 2). The master ECUs 2 are control units that control the pieces of onboard equipment 4 connected to the sub ECUs 3 at a bottom layer. The master ECUs 2 transmit signals to the sub ECUs 3. The master ECUs 2 also transmit control signals received from the sub ECUs 3 to another ECU or other ECUs via the central gateway ECU 1. The master ECUs 2 are equivalent to, for example, modules such as a battery control module (BCM) and an engine control module (ECM). The master ECUs 2 are connected to the central gateway ECU 1 via the buses 7 and connected to the sub ECUs 3 via the buses 8. The master ECUs 2 are connected to the buses 7 and 8 having different communication speeds. When signals are transferred between the central gateway ECU 1 and the sub ECUs 3, the master ECU 2 adjusts a transfer rate. The transfer rate is adjusted in such a manner as to save received data in a buffer and transmits the data in accordance with a communication speed of a transmission destination. In a case where a communication standard of the buses 7 is different from that of the buses 8, it is only necessary for the master ECUs 3 to change a data structure of the received data to a data structure that fits a format conforming to a communication standard of the transmission destination.

In a case where, unlike the example in FIG. 1, the communication network has an n-layer structure (n is a natural number greater than or equal to 4), and the master ECUs 2 are connected to, for example, nodes at a layer n-1, the master ECUs 2 are electrically connected to the central gateway ECU 1 via ECUs at a layer n-2 and the buses 7 and 8. Alternatively, in a case where the master ECUs 2 are connected to, for example, nodes at the layer n-2, the master ECUs 2 are electrically connected to the sub ECUs 3 via ECUs at the layer n-1 and the buses 7 and 8.

The sub ECUs 3 are ECUs located at the bottom layer (layer 3). The sub ECUs 3 are control units that control the pieces of onboard equipment 4. The sub ECUs 3 controls the pieces of onboard equipment 4 that are directly connected to the sub ECUs 3 with signal lines. A sub ECU 3 may control another sub ECU 3 that is connected to the sub ECU 3 via the central gateway ECU 1 and master ECUs 2.

Each piece of onboard equipment 4 is a component installed in the vehicle such as a battery, a motor, or a cooling fan and operates based on a control signal from an ECU.

The diagnosis connector 5 is an electronic component that connects the diagnosis device 6 to the vehicle network system 100 from the outside of the vehicle. The diagnosis device 6 is a computer that diagnoses an anomaly in an ECU, a piece of onboard equipment 4, or the like. The diagnosis device 6 includes a control program for diagnosis. The diagnosis device 6 executes the program to perform anomaly diagnosis. The diagnosis device 6 transmits a diagnosis signal to the vehicle network system 100 and receives a response signal from an ECU or a piece of onboard equipment being a diagnosis target. The diagnosis device 6 analyzes the response signal to determine whether any anomaly has occurred. The diagnosis device 6 also updates a program (software) included in an ECU. When updating the program, for example, the diagnosis device 6 transmits update data including a program for the update to the ECU being an update target. The ECU being the update target then downloads the update data and saves the update data in a memory. The ECU being the update target then updates the program by deleting data on a program to be updated and rewrites the update data. The connection between the diagnosis device 6 and the vehicle network system 100 is not limited to a wired connection and may be a wireless connection.

The buses 7 are signal lines that connect the central gateway ECU 1 and the master ECUs 2. The buses 8 are signal lines that connect the master ECUs 2 and the sub ECUs 3. The communication speed of the buses 7 is higher than the communication speed of the buses 8. The difference in communication speed is made by, for example, a difference in communication standard. Note that the buses 7 and the buses 8 may have the same communication speed, or the buses 8 may have a higher communication speed than the buses 7.

Here, with reference to FIG. 1, an operation state of a piece of onboard equipment 4 during the update of a program of a master ECU 2 will be described. Note that the piece of onboard equipment 4 connected to a sub ECU-1 is assumed to be a cooling fan. The cooling fan cools an onboard battery or the like. The cooling fan operates in response to an instruction signal (hereinafter, also referred to as a fan actuation instruction signal) from the master ECU-3. The master ECU-3 outputs the fan actuation instruction signal, switching between an on-instruction to turn on the cooling fan and an off-instruction to turn off the cooling fan. As illustrated with a dotted arrow in FIG. 1, the fan actuation instruction signal is transferred from the master ECU-3 to the central gateway ECU 1, the master ECU-1, and the sub ECU-1, in this order. The sub ECU-1 switches between on and off of the cooling fan in response to the fan actuation instruction signal. In addition, the sub ECU-1 drives the cooling fan under fail control. For example, in a case where the fan actuation instruction signal does not reach the sub ECU-1 for some reason, a fail-safe function of the sub ECU-1 is actuated, which causes the sub ECU-1 to output an instruction signal to turn on the cooling fan, thus driving the cooling fan.

For example, the diagnosis device 6 transmits an update instruction to update a program of the master ECU-1 to the vehicle network system 100. The central gateway ECU 1 outputs an instruction to update the program (a software update instruction) to the master ECU-1, which is an ECU being the update target. The master ECU-1 receives the instruction to update the program and downloads a program for the update. After the download is completed, the master ECU-1 once finishes processing by the program and rewrites the program. This state of rewriting the program is equivalent to a state of activating.

Here, in a case where the program being an update target includes a signal transfer program, the master ECU-1 cannot transfer a signal while the program is updated (in the state of activating). As a result, the fan actuation instruction signal does not reach the sub ECU-1. Thus, the sub ECU-1 fails to receive the fan actuation instruction signal and determines that a part of a communication function in the vehicle network system 100 has been in a failure state. The sub ECU-1 drives the cooling fan under the fail control.

In general, the program update of an ECU using the diagnosis device 6 is performed while the vehicle is parked. Therefore, in a case where the program update is started while the vehicle is parked, and the cooling fan is driven under the fail control, the cooling fan that is usually not driven in such a case is driven. In addition, when the cooling fan is driven, power consumption for driving the fan may decrease a voltage of the onboard battery. Then, the program update of the ECU is suspended to restrain the voltage of the battery from being decreased. It may be necessary to perform a task such as connecting a charger to charge the onboard battery. Thus, the present embodiment is configured such that a signal transfer function of an ECU does not fail while a program of the ECU is updated.

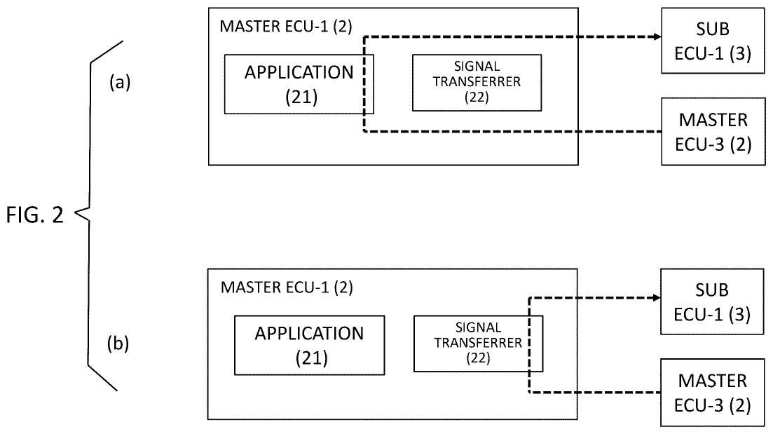

FIG. 2 is a block diagram for describing a configuration of a master ECU 2. The following will describe a configuration of the master ECU-1, and the other master ECUs 2 may have the same configuration.

The master ECU-1 includes an application 21 and a signal transferrer 22. The application 21 includes a program to control pieces of onboard equipment 4 and the like and has at least a function of transmitting and receiving signals between ECUs. The program included in the application 21 is, for example, data in which control instructions to control driving sources of the vehicle such as an engine, a motor, and a battery, control instructions to control auxiliary devices such as headlights, a navigation system, and an air conditioner, and control instructions to control autonomous driving systems such as a lane keeping system and a following distance keeping system are written. The application 21 includes a processor that controls the pieces of onboard equipment 4 by executing processing based on the instructions written in the program. The application 21 may control a piece of onboard equipment 4 in coordination with an application 21 included in another ECU. For example, in the autonomous driving system, a plurality of pieces of onboard equipment 4 are controlled by a plurality of ECUs that need to control many pieces of onboard equipment 4 including a steering wheel, an accelerator, brakes, and sensors such as a camera and a sonar, using signals common within the vehicle network system 100.

In the program of the application 21, control instructions to transmit and receive signals between ECUs are written. That is, the application 21 executes the instructions written in the program to execute a function of transmitting and receiving signals between ECUs. In the program of the application 21, instructions to execute a self-diagnostic function may be written. The self-diagnostic function is a function of diagnosing, for example, whether the processor of the application 21 operates normally.

The signal transferrer 22 transfers a signal received from one of ECUs connected to the master ECU-1 to another one of the ECUs connected to the master ECU-1. In the example of FIG. 2, the master ECU-1 transfers a signal that is received from the master ECU-3 via the central gateway ECU 1 to the sub ECU-1. The signal transferrer 22 performs not only transferring a signal but also processing necessary to transfer a signal between ECUs. For example, in a case where a bus of a received signal differs in communication standard from a bus of a transmitted signal or in a case where the buses have different communication speeds, the signal transferrer 22 performs signal processing on the received signal such that the received signal fits the communication standard and a transfer rate of a bus of a transmission destination. The signal transferrer 22 may manage an ID that indicates a transmission destination. For example, in a case where a piece of onboard equipment 4 being a control target of the master ECU-1 is replaced due to component replacement or the like, the signal transferrer 22 associates an ID of the piece of onboard equipment 4 before the replacement with and an ID of a piece of onboard equipment 4 after the replacement and stores the IDs in a memory. Then, when a signal given the ID of the piece of onboard equipment 4 before the replacement is received, the signal transferrer 22 changes the ID to the ID of the piece of onboard equipment 4 after the replacement before transmitting the signal.

As seen from the above, the master ECU-1 has a plurality of functions to transfer a signal between ECUs, and the program (software) and signal systems (buses) to execute the transfer functions are sorted in accordance with the signal transfer function. The master ECU-1 switches the signal transfer function to select which of the application 21 and the signal transferrer 22 is to be used to execute the signal transfer processing in accordance with whether the program included in the application 21 is being updated. Specifically, when the program included in the application 21 is in a state of being readable (hereinafter, also referred to as a readable state), the master ECU-1 uses the application 21 to transfer a signal between ECUs. That is, the master ECU-1 causes the processor to read instructions written in the program of the application 21 and transfer a signal between ECUs. In contrast, when the master ECU-1 receives an update instruction to update the program included in the application 21 from the diagnosis device 6, the master ECU-1 downloads a program for the update from the diagnosis device 6 and saves the program for the update in a memory. Until the download of the program for the update is completed, the program included in the application 21 is in the readable state, and thus the application 21 may transfer a signal between ECUs.

Then, after completing the download, the master ECU-1 switches a program to execute the signal transfer processing from the application 21 to the signal transferrer 22. In a case where the program included in the application 21 is operating (the program has been read), the master ECU-1 is to switch the program after the processing by the program is finished. When the update instruction to update the program is received, the master ECU-1 may execute diagnosis processing by the application 21 before updating the program. After a result of the diagnosis is confirmed to be normal, the master ECU-1 may execute the signal transfer processing with the signal transferrer 22.

To transfer a signal between ECUs while the program included in the application 21 is updated, the master ECU-1 uses the signal transferrer 22 to transfer the signal between the ECUs. While the program included in the application 21 is updated, the program being the update target is in a state of being unreadable. As seen from the above, when the program included in the application 21 is in the state of being readable, the application 21 transmits a signal received from one of ECUs to another one of the ECUs. While the program included in the application 21 is updated, the signal transferrer 22 transmits a signal received from one of ECUs to another one of the ECUs. Note that the state in which the program is readable is equivalent to a state where the functions of the application 21 are made available by the processor of the master ECU-1 caused to read the program and process instructions written in the program. In contrast, a state of updating the program is equivalent to a state where the functions of the application 21 are unavailable.

In the example in FIG. 2, the master ECU-3 transmits an instruction signal to control a piece of onboard equipment 4 that is connected to the sub ECU-1. As illustrated in FIG. 2(a), when the program included in the application 21 is in the readable state, and the master ECU-1 receives a signal from the master ECU-3, the application 21 transmits the received signal to the sub ECU-1. As illustrated in FIG. 2(b), when the master ECU-1 receives a signal from the master ECU-3 while the program included in the application 21 is updated, the signal transferrer 22 transmits the received signal to the sub ECU-1. Thus, it is possible to transmit and receive a signal between ECUs while the program included in the application 21 is updated.

As described above, in the present embodiment, the master ECU 2 includes the application 21 including the program, and transmitting and receiving signals between a sub ECU 3 and an ECU (equivalent to the central gateway ECU 1, a master ECU 2, and/or a sub ECU 3) and includes the signal transferrer 22 transferring a signal received from the ECU to the sub ECU 3. When the program is in the state of being readable, the application 21 transmits the signal received from the ECU to the sub ECU 3, and the signal transferrer 22 transmits a signal received from the ECU to the sub ECU 3 while the program is updated. Thus, while the program included in the master ECU 2 is updated, it is possible to transmit and receive signals between other ECUs via the master ECU 2 including the program.

In the present embodiment, the master ECU 2 executes the signal transfer processing in which the master ECU 2 receives a signal from an ECU (equivalent to the central gateway ECU 1, a master ECU 2, and/or a sub ECU 3) through bus 7 that connects the master ECU 2 and the ECU (equivalent to a “first bus” according to the present invention), and the master ECU 2 transmits the signal to a sub ECU 3 through a bus 8 that connects the master ECU 2 and the sub ECU 3 (equivalent to a “second bus” according to the present invention). In addition, the master ECU 2 updates the program included in the application 21 to execute the signal transfer processing. The signal transfer processing includes processing of transmitting a signal received from the ECU to the sub ECU 3 with the application 21 when the program is in the state of being readable, and includes processing of transmitting a signal received from the ECU to the sub ECU 3 with the signal transferrer 22 included in the master ECU 2 while the program is updated. Thus, via the master ECU 2, signals can be transmitted and received between other ECUs while the program included in the master ECU 2 is updated.

In the present embodiment, the application 21 receives, from the ECU, a control signal to control a piece of onboard equipment 4 (equivalent to a “piece of electronic equipment” according to the present invention) connected to the sub ECU 3 and transmits the control signal to the sub ECU 3. Thus, via the master ECU 2, the control signal for the piece of onboard equipment 4 can be transmitted from the ECU to the master ECU 3 while the program included in the master ECU 2 is updated.

In the present embodiment, when the update instruction to update the program is received, the master ECU 2 executes the diagnosis processing with the application 21, and after a result of the diagnosis is confirmed to be normal, the master ECU 2 executes the signal transfer processing with the signal transferrer 22. Thus, it is possible to determine whether an anomaly has occurred in the master ECU 2 before the program is updated.

In the present embodiment, when the sub ECU 3 fails to receive, from the ECU, a control signal for the piece of onboard equipment 4 connected to the sub ECU 3, the sub ECU 3 drives the piece of onboard equipment 4 under the fail control, and while the program is updated, the signal transferrer 22 transmits the control signal received from the ECU to the sub ECU 3. Thus, it is possible to prevent the piece of onboard equipment 4 from being driven under the fail control while the program is updated.

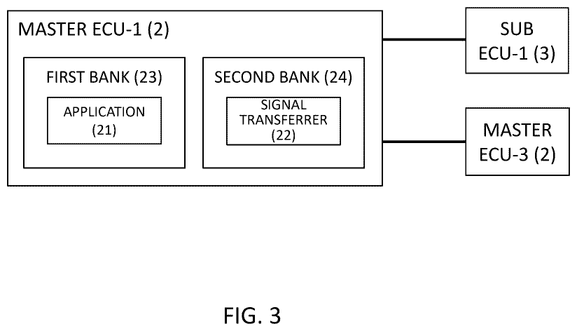

As a modification of the master ECU 2, the master ECU 2 may include a plurality of banks. FIG. 3 is a block diagram of a master ECU-1 according to the modification. The master ECU-1 includes a plurality of banks into which an application area is partitioned. In an example in FIG. 3, the plurality of banks are two banks including a first bank 23 and a second bank 24. However, the number of banks may be three or more. The first bank 23 includes the application 21, and the second bank 24 includes the signal transferrer 22. When the master ECU-1 receives, from the diagnosis device 6, an update signal to update the program included in the application 21, the master ECU-1 starts downloading the program for the update. While or before downloading the program for the update, the master ECU-1 switches the signal transfer function from the application 21 to the signal transferrer 22. When the download of the program for the update is completed, the master ECU-1 rewrites the program saved in the first bank to the program for the update, thus switching an application area of the first bank to a new area. The master ECU-1 then switches the signal transfer function from the signal transferrer 22 to the application 21. Note that programs or applications saved in the first bank 23 and the second bank 24 may be subjected to what is called mirroring in which the programs or the applications are made identical between the first bank 23 and the second bank 24.

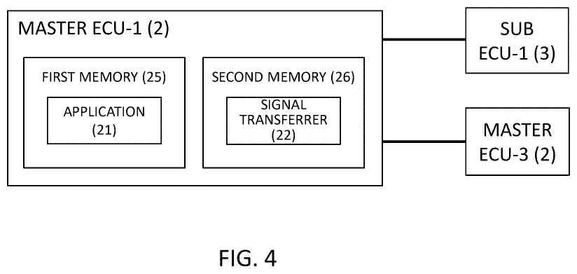

As a modification of the master ECU 2, the master ECU 2 may include a plurality of memories, store the application 21 in a first memory, and store a processing program to cause the signal transferrer 22 to execute the signal transfer processing in a second memory. FIG. 4 is a block diagram of a master ECU-1 according to the modification. The master ECU-1 includes a plurality of memories. In an example in FIG. 4, the plurality of memories are two memories including a first memory 25 and a second memory 26. However, the number of memories may be three or more. The first memory 25 includes the application 21, and the second memory 26 includes the signal transferrer 22. The second memory 26 is equivalent to a chip for signal transfer (data transfer) between ECUs. As in the above-described modification illustrated in FIG. 3, when updating the program included in the application 21, the master ECU-1 switches the signal transfer function from the application 21 to the signal transferrer 22 while or before downloading the program for the update. Thus, a channel of the signal transfer between ECUs is switched. Note that the update of the program and the switch of signal transfer channels can be described by replacing, in the above-mentioned description of the modification, the first bank 23 with the first memory 25 and the second bank 24 with the second memory 26. Note that, in the modification illustrated in FIG. 4, an application area of the master ECU-1 may include a single bank or a plurality of banks.

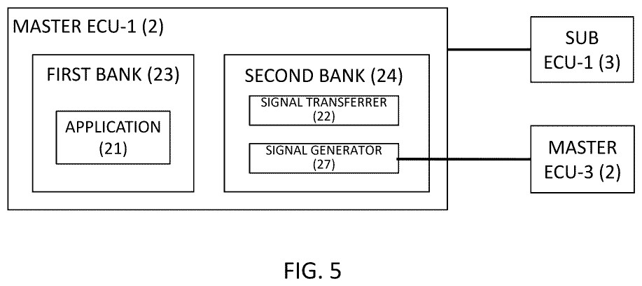

As a modification of the master ECU 2, the master ECU 2 may include a signal generator 27 that generates an anomaly diagnosis instruction to diagnose an anomaly in another master ECU 2 or sub ECU 3. FIG. 5 is a block diagram of a master ECU-1 according to the modification. The master ECU-1 includes the first bank 23 and the second bank 24. The first bank 23 includes the application 21, and the second bank 24 includes the signal transferrer 22 and the signal generator 27. The signal generator 27 transmits the anomaly diagnosis instruction to the master ECU-3 while the program included in the application 21 is updated. Upon receiving the anomaly diagnosis instruction, the master ECU-3 executes an anomaly diagnosis with the self-diagnostic function. In a case where the anomaly diagnosis is performed on a sub ECU 3, the signal generator 27 is to add an ID of the sub ECU 3 to the anomaly diagnosis instruction and transmit the instruction to the sub ECU 3. Thus, the master ECU-1 can transmit the anomaly diagnosis instruction to another ECU while its application is updated. Note that, in the modification of the master ECU 2 illustrated in FIG. 5, an application area of the master ECU-1 may include a single bank. Alternatively, the master ECU-1 may include one memory that is partitioned into a plurality of application areas serving as a plurality of banks or may allocate an application area across a plurality of memories.

Note that, in the present embodiment, the application 21 and the signal transferrer 22 may transfer a signal between a sub ECU 3 and the central gateway ECU 1, between a sub ECU 3 and a master ECU 2, and/or between a plurality of sub ECUs 3.

The embodiment explained above is described to facilitate understanding of the present invention and is not described to limit the present invention. It is therefore meant that the constituent elements disclosed in the above embodiment include all design changes and equivalents falling within the technical scope of the present invention.

### DESCRIPTION OF REFERENCE NUMERALS

1 central gateway ECU
2 master ECU
3 sub ECU
4 onboard equipment
5 diagnosis connector
6 diagnosis device
7 bus
8 bus
21 application
22 signal transferrer
23 first bank
24 second bank
25 first memory
26 second memory
27 signal generator
100 vehicle network system

1. An electronic control apparatus comprising:
a master ECU;
an ECU electrically connected to the master ECU via a first bus; and
a sub ECU electrically connected to the master ECU via a second bus and the master ECU: wherein
the master ECU includes,
an application that includes a program, and transmits and receives a signal between the sub ECU and the ECU; and
a signal transferrer that transfers a signal received from the ECU to the sub ECU,
wherein the ECU transmits, to the master ECU, a control signal to control an electronic device connected to the sub ECU,
wherein the application transmits the control signal received from the ECU to the sub ECU when the program is in a state of being readable,
wherein the sub ECU drives the electronic device under fail control when the control signal is failed to be received, and
wherein the signal transferrer transmits the control signal received from the ECU to the sub ECU while the program is updated.

2. The electronic control apparatus according to claim 1, wherein
the master ECU includes a plurality of banks into which an application area is partitioned,
a first bank of the plurality of banks includes the application, and
a second bank of the plurality of banks includes the signal transferrer.

3. The electronic control apparatus according to claim 1, wherein
a first memory of the plurality of memories stores the application, and
a second memory of the plurality of memories stores a processing program that causes the signal transferrer to execute signal transfer processing.

4. The electronic control apparatus according to claim 1, wherein
the master ECU includes a signal generator that generates an anomaly diagnosis instruction to diagnose an anomaly in the ECU, and
the signal generator transmits the anomaly diagnosis instruction to the sub ECU while the program is updated.

5. The electronic control apparatus according to claim 1, wherein
when an update instruction to update the program is received, the master ECU executes diagnosis processing with the application, and after a result of diagnosis is confirmed to be normal, the master ECU executes signal transfer processing with the signal transferrer.

6. An electronic control method for controlling a piece of electronic equipment, the electronic control method comprising:
executing signal transfer processing of receiving a signal from an ECU through a first bus and transmitting the signal to a sub ECU through a second bus, the first bus connecting a master ECU and the ECU, the second bus connecting the master ECU and the sub ECU;
updating a program included in an application to execute the signal transfer processing;
transmitting, to the master ECU, a control signal to control an electronic device connected to the sub ECU; and
outputting, to the electric device, an instruction signal to be driven under fail control when the control signal is failed to be received,
wherein the signal transfer processing includes:
processing of transmitting, with the application, the control signal received from the ECU to the sub ECU when the program is in a state of being readable; and
processing of transmitting, with a signal transferrer included in the master ECU, the control signal received from the ECU to the sub ECU while the program is updated.

7. (canceled)

8. (canceled)
